(19) United States
(12) Patent Application Publication
(10) Pub. No.: US 2023/0307756 A1
(43) Pub. Date: Sep. 28, 2023

(54) CELL ROW SEPARATORS FOR TRACTION BATTERY PACKS WITH CELL-TO-PACK BATTERY SYSTEMS

(71) Applicant: FORD GLOBAL TECHNOLOGIES, LLC, Dearborn, MI (US)

(72) Inventors: Patrick Daniel Maguire, Ann Arbor, MI (US); Marc Dugas, Wixom, MI (US)

(21) Appl. No.: 17/851,697

(22) Filed: Jun. 28, 2022

Related U.S. Application Data
(60) Provisional application No. 63/322,766, filed on Mar. 23, 2022.

(51) Int. Cl. H01M 50/209; H01M 50/289; H01M 10/04; H01M 50/249

(52) U.S. Cl. CPC H01M 50/209; H01M 50/289; H01M 10/0481; H01M 50/249; H01M 2220/20

(57) ABSTRACT

Cell row separators are disclosed for use within traction battery packs that include cell-to-pack battery systems. An exemplary cell-to-pack battery system may include a first cell stack, a second cell stack, and a cell row separator secured to both the first cell stack and the second cell stack. The separator is adapted for structurally coupling the first cell stack and the second cell stack together.

### CROSS-REFERENCE TO RELATED APPLICATIONS

This disclosure claims priority to U.S. Provisional Application No. 63/322,766, which was filed on Mar. 23, 2022 and is incorporated herein by reference.

### TECHNICAL FIELD

This disclosure relates generally to traction battery packs, and more particularly to cell row separators for use within traction battery packs that include cell-to-pack battery systems.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack can power the electric machines and other electrical loads of the vehicle.

Conventional traction battery packs include groupings of battery cells called battery arrays. The battery arrays include various array support structures (e.g., array frames, spacers, rails, walls, end plates, bindings, etc.) that are arranged for grouping and supporting the battery cells in multiple individual units inside the traction battery pack enclosure.

### SUMMARY

A traction battery pack according to an exemplary aspect of the present disclosure includes, among other things, an enclosure assembly and a cell-to-pack battery system housed within the enclosure assembly. The cell-to-pack battery system includes a first cell stack, a second cell stack, and a cell row separator arranged to structurally couple the first cell stack and the second cell stack together.

In a further non-limiting embodiment of the foregoing traction battery pack, the enclosure assembly includes an enclosure cover and an enclosure tray.

In a further non-limiting embodiment of either of the foregoing traction battery packs, the enclosure tray provides a cell-compressing opening for compressing the first cell stack and the second cell stack.

In a further non-limiting embodiment of any of the foregoing traction battery packs, the cell row separator is secured to the first cell stack by a first two-sided adhesive tape and is secured to the second cell stack by a second two-sided adhesive tape.

In a further non-limiting embodiment of any of the foregoing traction battery packs, a structural adhesive is received between a first projection and a second projection of the cell row separator.

In a further non-limiting embodiment of any of the foregoing traction battery packs, the cell row separator is a polymer-based component.

In a further non-limiting embodiment of any of the foregoing traction battery packs, the cell row separator includes a base and a plurality of projections that protrude upwardly from the base.

In a further non-limiting embodiment of any of the foregoing traction battery packs, the plurality of projections are spaced apart from one another along a length of the base, and a gap extends between adjacent projections of the plurality of projections.

In a further non-limiting embodiment of any of the foregoing traction battery packs, a structural adhesive is received within the gap.

In a further non-limiting embodiment of any of the foregoing traction battery packs, the cell-to-pack battery system establishes a total high voltage bus electrical potential of the traction battery pack.

A traction battery pack according to another exemplary aspect of the present disclosure includes, among other things, a cell stack, a cell row separator attached to the cell stack and including a base, a first projection that extends from the base, and a second projection that extends from the base, and a structural adhesive received within a gap extending between the first projection and the second projection.

In a further non-limiting embodiment of the foregoing traction battery pack, the cell row separator is a polymer-based component.

In a further non-limiting embodiment of either of the foregoing traction battery packs, the first and second projections are finger-like projections.

In a further non-limiting embodiment of any of the foregoing traction battery packs, the first and second projections taper toward a distal end portion.

In a further non-limiting embodiment of any of the foregoing traction battery packs, the traction battery pack includes a second cell stack. The cell row separator is attached to the second cell stack.

In a further non-limiting embodiment of any of the foregoing traction battery packs, the cell row separator and the structural adhesive cooperate to structurally couple the cell stack and the second cell stack together.

In a further non-limiting embodiment of any of the foregoing traction battery packs, the cell row separator is secured to the cell stack by a two-sided adhesive tape.

In a further non-limiting embodiment of any of the foregoing traction battery packs, the cell stack includes a plurality of battery cells. The cell row separator provides a common datum reference plane for aligning the plurality of battery cells.

In a further non-limiting embodiment of any of the foregoing traction battery packs, the cell-to-pack battery system establishes a total high voltage bus electrical potential of the traction battery pack.

A method according to another exemplary aspect of the present disclosure includes, among other things, assembling a first cell stack, attaching a cell row separator to the first cell stack, arranging a second cell stack adjacent to the first cell stack, compressing the first cell stack and the second cell stack together to form a cell matrix, and while maintaining compression on the cell matrix, moving the cell matrix into a cell-compressing opening of an enclosure tray of a traction battery pack.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack of the electrified vehicle of FIG. 1.

FIG. 3 illustrates a cell-to-pack battery system of the traction battery pack of FIG. 2.

FIG. 4 illustrates an exemplary cell row separator of a cell-to-pack battery system.

FIG. 5 is a top view of select portions of a cell matrix of a cell-to-pack battery system.

FIG. 6 illustrates another exemplary cell matrix of a cell-to-pack battery system.

FIGS. 7, 8, 9, and 10 schematically illustrate a method of assembling a traction battery pack that includes a cell-to-pack battery system.

FIG. 11 illustrates another exemplary cell row separator of a cell-to-pack battery system.

FIG. 12 illustrates an interface between a cell row separator and an enclosure cover of a traction battery pack.

### DETAILED DESCRIPTION

This disclosure details cell row separators for use within traction battery packs that include cell-to-pack battery systems. An exemplary cell-to-pack battery system may include a first cell stack, a second cell stack, and a cell row separator secured to both the first cell stack and the second cell stack and adapted for structurally coupling the first cell stack and the second cell stack together. These and other features are discussed in greater detail in the following paragraphs of this detailed description.

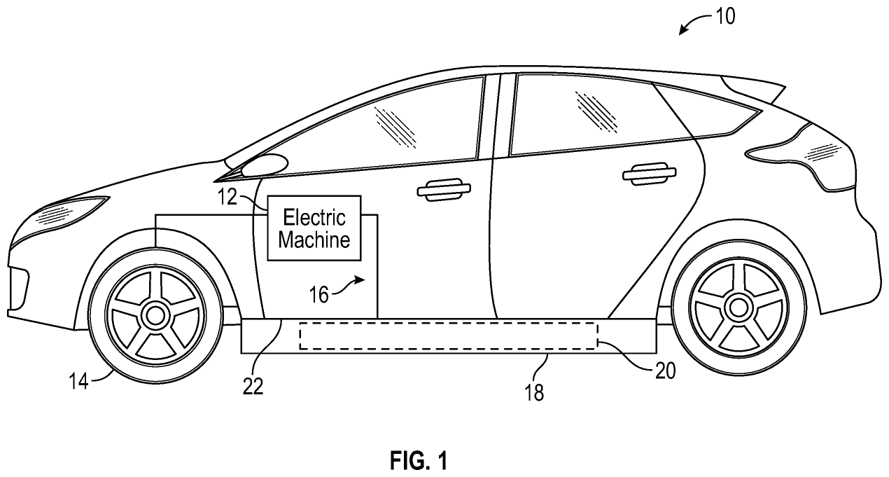

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In an embodiment, the electrified vehicle 10 is a car. However, the electrified vehicle 10 could alternatively be a pickup truck, a van, a sport utility vehicle (SUV), or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more drive wheels 14 of the electrified vehicle 10.

A voltage bus 16 may electrically couple the electric machine 12 to a traction battery pack 18. The traction battery pack 18 is capable of outputting electrical power to power the electric machine 12 and/or other electrical loads of the electrified vehicle 10.

The traction battery pack 18 may be secured to an underbody 22 of the electrified vehicle 10. However, the traction battery pack 18 could be located elsewhere on the electrified vehicle 10 within the scope of this disclosure.

The traction battery pack 18 is an exemplary electrified vehicle battery. The traction battery pack 18 may be a high voltage traction battery pack that includes a cell-to-pack battery system 20. Unlike conventional traction battery pack battery systems, the cell-to-pack battery system 20 incorporates battery cells or other energy storage devices without the cells being arranged in individual arrays or modules. The cell-to-pack battery system 20 therefore eliminates most if not all the array support structures (e.g., array frames, spacers, rails, walls, end plates, bindings, etc.) necessary for grouping the battery cells into the arrays/modules. Further, the cell-to-pack battery system 20 may provide the total high voltage bus electrical potential of the traction battery pack 18 with a single battery unit as opposed to conventional battery systems that require multiple individual battery arrays/modules that must be connected together after being positioned within the battery enclosure for achieving the total high voltage electrical potential.

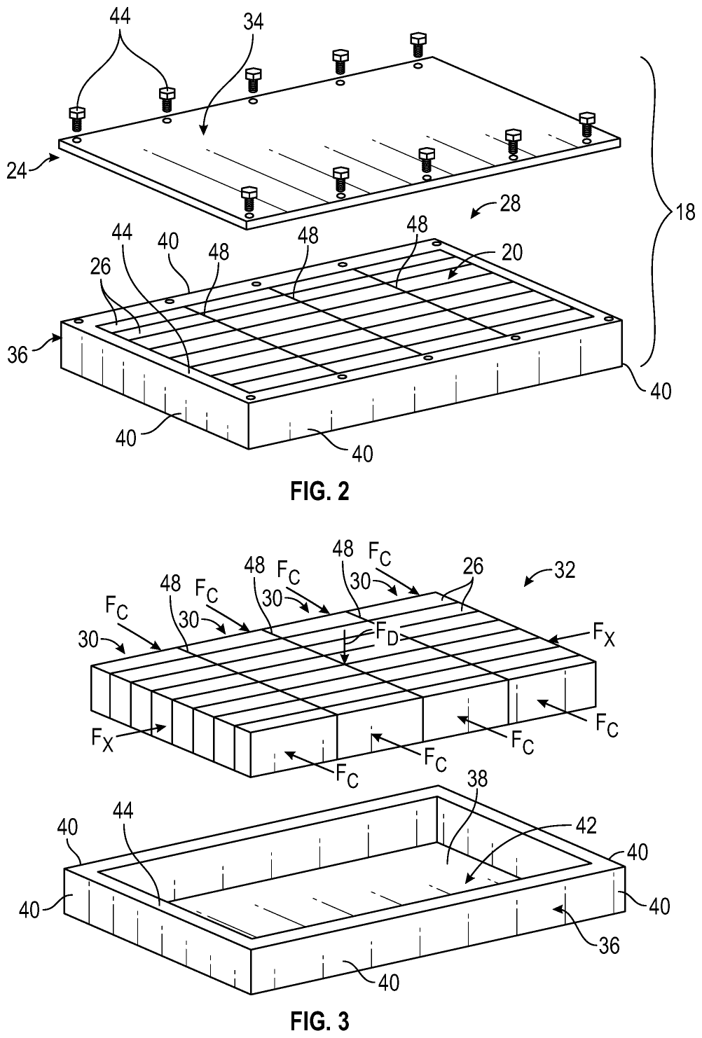

Referring now to FIGS. 2 and 3, the traction battery pack 18 may include an enclosure assembly 24 that is arranged for housing the cell-to-pack battery system 20. In an embodiment, the cell-to-pack battery system 20 includes a plurality of battery cells 26 that are held within an interior area 28 established by the enclosure assembly 24.

The battery cells 26 may supply electrical power to various components of the electrified vehicle 10. The battery cells 26 may be stacked side-by-side relative to one another to construct a cell stack 30, and the cell stacks 30 may be positioned side-by-side in rows to provide a cell matrix 32.

In an embodiment, each cell stack 30 includes eight individual battery cells 26, and the cell matrix 32 includes four cell stacks 30 for a total of thirty-two battery cells 26. Providing an even quantity of battery cells 26 and an even quantity of cell stacks 30 can help to support an efficient electrical bussing arrangement. Although a specific number of battery cells 26 and cells stacks 30 are illustrated in the various figures of this disclosure, the cell-to-pack battery system 20 of the traction battery pack 18 could include any number of battery cells 26 and any number of cell stacks 30. In other words, this disclosure is not limited to the exemplary configuration shown in FIGS. 2 and 3.

In an embodiment, the battery cells 26 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The enclosure assembly 24 of the traction battery pack 18 may include an enclosure cover 34 and an enclosure tray 36. The enclosure cover 34 may be secured to the enclosure tray 36 to provide the interior area 28 for housing the cell-to-pack battery system 20.

The enclosure tray 36 may include a floor 38 and a plurality of side walls 40 arranged relative to one another to provide a cell-compressing opening 42. The floor 38 and the side walls 40 may be mechanically coupled to one another, such as by welding, for example.

During assembly of the traction battery pack 18, the enclosure cover 34 may be secured to the enclosure tray 36 at an interface 44 that substantially circumscribes the interior area 28. Mechanical fasteners 46 may be used to secure the enclosure cover 34 to the enclosure tray 36, although other fastening methodologies could also be suitable.

The cell matrix 32 of the cell-to-pack battery system 20 may be positioned within the cell-compressing opening 42 provided by the enclosure tray 36. The exemplary enclosure tray 36 is depicted as including a single cell-compressing opening 42, however it should be understood that this disclosure extends to structural assemblies that provide one or more cell-compressing openings. The enclosure cover 34 may cover the cell matrix 32 within the cell-compressing opening 42 to substantially surround the battery cells 26 on all sides. Once fully assembled and positioned relative to the enclosure tray 36, the cell matrix 32 may establish a single battery unit capable of providing the total high voltage bus electrical potential of the traction battery pack 18.

The enclosure tray 36 may compress and hold the cell matrix 32 when the cell matrix 32 is received within the cell-compressing opening 42. In an embodiment, the side walls 40 of the enclosure tray 36 apply forces to the cell matrix 32 when the cell matrix 32 is positioned within the cell-compressing opening 42.

In an embodiment, in order to insert the cell matrix 32 into the cell-compressing opening 42, the cell matrix 32 may first be compressed, and then, while compressed, moved into place in the cell-compressing opening 42. A compressive force F_{C} may be applied to opposed ends of one of the cell stacks 30. The compressive force F_{C} essentially squeezes the battery cells 26 within the cell stack 30, thereby compressing the cell stack 30 and the individual battery cells 26 to a reduced thickness. While the compressive force F_{C} is applied to the cell stack 30, the cell stack 30 may be inserted into a respective cell-compressing opening 42 by a downward force F_{D}. The downward force F_{D} may be applied directly to one or more of the battery cells 26.

While the term “downward” is used herein to describe the downward force F_{D}, it should be understood that the term “downward” is used herein to refer to all forces tending to press a cell stack 30 into a cell compressing opening 42. In particular, the term “downward” refers to all forces substantially perpendicular to the compressive force F_{C}, whether or not the force is truly in a “downward” direction. For example, this disclosure extends to cell stacks that are compressed and inserted into a cell-compressing opening in a sideways direction.

The cell stacks 30 could be individually compressed and inserted into the cell-compressing opening 42. In another embodiment, the entire cell matrix 32 is compressed and inserted into the cell-compressing opening 42. As schematically shown in FIG. 3, in such an embodiment, additional, compressive forces F_{X} can compress the cell stacks 30 together for insertion into the cell-compressing opening 42. The compressive forces F_{X} are generally perpendicular to the compressive forces F_{C}. The compressive forces F_{X} may be applied together with the compressive forces F_{C}. The force F_{D} may then be applied to move the entire cell matrix 32 into the cell-compressing opening 42.

In an embodiment, an entire perimeter of the cell-compressing opening 42 is defined by the side walls 40 of the enclosure tray 36. The side walls 40 can apply a compressive force to the battery cells 26 about the entire perimeter of the cell matrix 32. The side walls 40 may therefore function as a rigid halo-type structure that compresses and tightly holds the cell matrix 32.

The configuration described above is considered to be a cell-to-pack type battery pack, which differs from conventional battery pack types that include enclosures holding arrays of battery cells enclosed by array support structures that are spaced apart from walls of a battery enclosure, and where the battery enclosure does not apply compressive forces to any of the battery cells.

The cell-to-pack battery system 20 may further include one or more cell row separators 48. In an embodiment, one cell row separator 48 is positioned between each adjacent pair of cell stacks 30 of the cell matrix 32. In other embodiments, two cell row separators 48 are provided with each cell stack 30. However, the total number of cell row separators 48 provided within the cell-to-pack battery system 20 is not intended to limit this disclosure.

As further detailed below, the cell row separators 48 may provide various functions and advantages to the cell-to-pack battery system 20, including but not limited to maintaining battery cells 26 of adjacent cell stacks 30 spaced apart from one another, adding stiffness across the cell matrix 32 to prevent drooping and/or buckling, providing a common datum reference point for aligning battery cells 26 of each cell stack 30, etc. The functionality provided by the cell row separators 48 described herein may be particularly beneficial for cell-to-pack type battery systems because the array support structures traditionally provided within battery arrays has been largely eliminated from the cell-to-pack battery system 20.

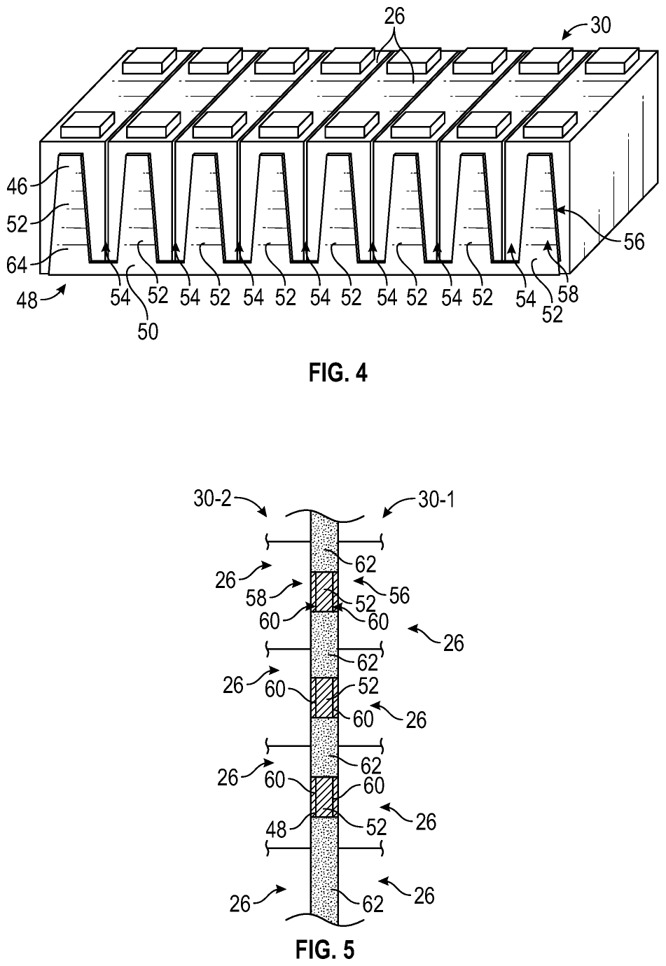

FIG. 4, with continued reference to FIGS. 1-3, illustrates an exemplary design of a cell row separator 48 of the cell-to-pack battery system 20. The cell row separator 48 may be a polymer-based component. For example, the cell row separator 48 could be constructed out of a sheet moulding compound (e.g., glass-fiber reinforced polyester), polypropylene, polyamide, etc.

The cell row separator 48 may include a base 50 and a plurality of finger-like projections 52 that protrude upwardly from the base 50. Together, the base 50 and the projections 52 may establish a unitary, single-piece structure of the cell row separator 48.

The projections 52 may be spaced apart from one another along a length of the base 50. The total number of projections 52 provided within the cell row separator 48 is not intended to limit this disclosure. Due to their spaced relationship, a gap 54 may extend between each adjacent pair of projections 52.

The projections 52 may extend vertically away from the base 50 along longitudinal axes that are parallel to one another. Each projection 52 may include a cantilevered design that extends between a proximal end portion 64 proximate the base 50 and a distal end portion 66 that is spaced from the base 50. The projections 52 may extend to a height that is either greater than or less than a corresponding height of the battery cells 26 of the cell stack 30.

In an embodiment, each projection 52 tapers in a direction toward the distal end portion 66. However, other configurations could also be possible.

The cell row separator 48 may further include a first side surface 56 and a second side surface 58 that is opposed to the first side surface 56. The first side surface 56 may be secured directly to the battery cells 26 of one of the cell stacks 30, and the second side surface 58 may be secured to an adjacent cell stack 30 of the cell matrix 32. In an embodiment, the cell row separator 48 is secured to one or more longitudinally extending sides of the cell stack 30. However, the cell row separator 48 could be secured to any side of the cell stack 30. Notably, the cell row separator 48 is not secured directly to the enclosure tray 36.

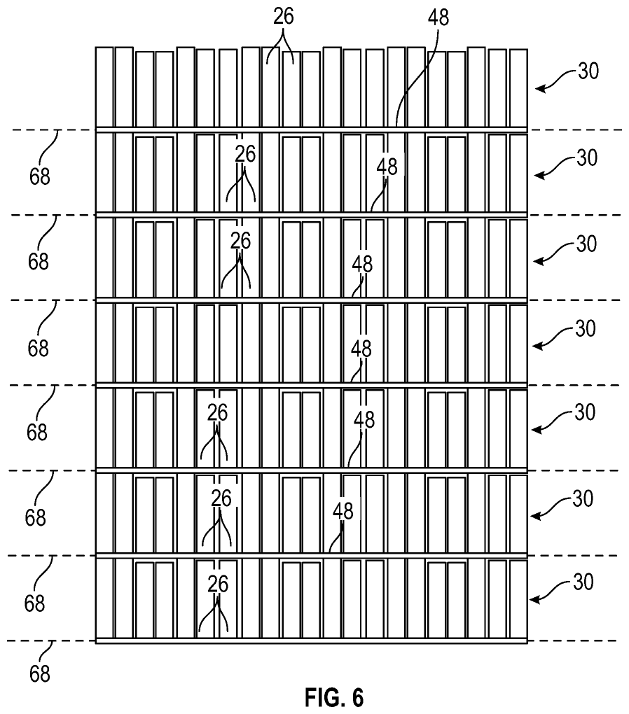

Referring now to FIG. 5, the cell row separator 48 may be secured to both a first cell stack 30-1 and a second cell stack 30-2 of the cell matrix 32, such as with one or more sections of two-sided adhesive tape 60. In the illustrated embodiment, the first side surface 56 of the cell row separator 48 is secured directly to the battery cells 26 of the first cell stack 30-1 by one or more pieces of the two-sided adhesive tape 60, and the second side surface 58 of the cell row separator 48 is secured directly to the battery cells 26 of the second cell stack 30-2 by another piece/pieces of the two-sided adhesive tape 60. In this position, the cell row separator 48 may prevent the battery cells 26 of the first cell stack 30-1 from contacting the battery cells 26 of the second cell stack 30-2.

The gaps 54 may establish open areas between the cell stacks 30-1, 30-2 for receiving a structural adhesive 62. The projections 52, the base 50, and the battery cells 26 of the adjacent cell stacks 30-1, 30-2 may establish a containment perimeter about the structural adhesive 62 for confining the adhesive to desired locations of the cell matrix 32. Once cured, the structural adhesive 62 can add stiffness to the cell matrix 32, thereby preventing drooping and/or buckling and structurally coupling the cell stacks 30-1, 30-2 together. The structural adhesive 62 may be an epoxy or any other suitable adhesive.

Each cell row separator 48 may further provide a common datum reference plane 68 (see FIG. 6) for aligning and grouping the battery cells 26 of each cell stack 30. The common datum reference plane 68 may be especially useful as an assembly tool when the battery cells 26 of the cell stacks 30 have slightly different sizes due to tolerance stack ups and other manufacturing complexities.

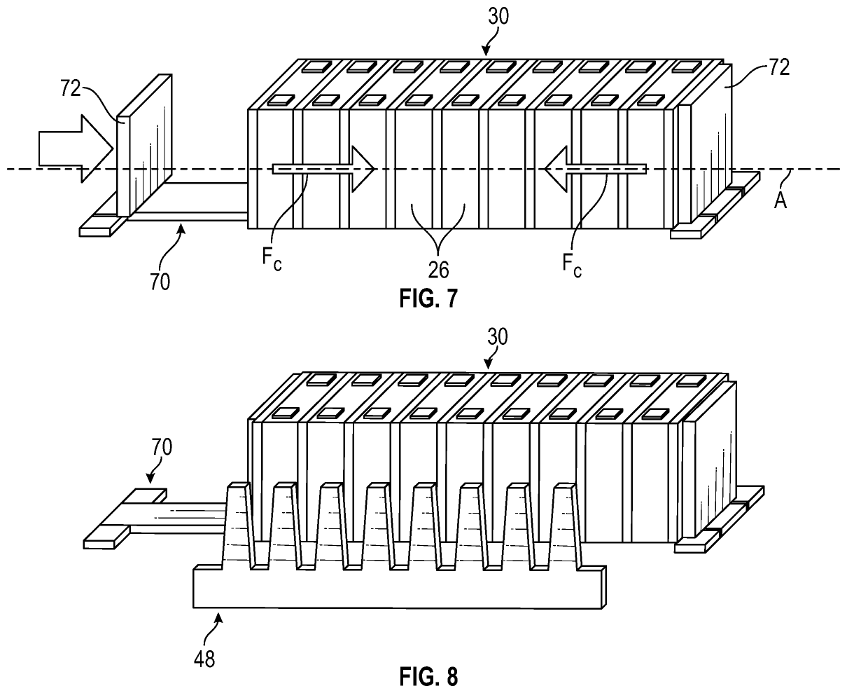

FIGS. 7, 8, 9, and 10, with continued reference to FIGS. 1-6, schematically illustrate a method of assembling a traction battery pack 18 that includes a cell-to-pack battery system 20. It should be understood that the exemplary method could include fewer or additional steps than are recited below. In addition, the inventive method of this disclosure is not limited to the exact order and/or sequence described in the embodiments detailed herein.

Referring first to FIG. 7, a plurality of battery cells 26 may be arranged within a cell row vise 70. The battery cells 26 may be compressed together along a longitudinal axis A to construct a cell stack 30. In an embodiment, opposing compression plates 72 of the cell row vise 70 may be arranged for applying compressive forces F_{C} to the two outward-most positioned battery cells 26. The compressive forces F_{C} essentially squeeze the battery cells 26 together to form the cell stack 30. These steps may be repeated using one or more additional cell row vises 70 to construct as many cell stacks 30 as is desired or necessary for a given traction battery pack design.

Next, as shown in FIG. 8, with the cell stack 30 still held within the cell row vise 70, the cell row separator 48 may be secured to the cell stack 30. In certain embodiments, cell row separators 48 may be secured to two opposing longitudinally extending sides of the cell stack 30. This step may be repeated for one or more additional cell stacks 30.

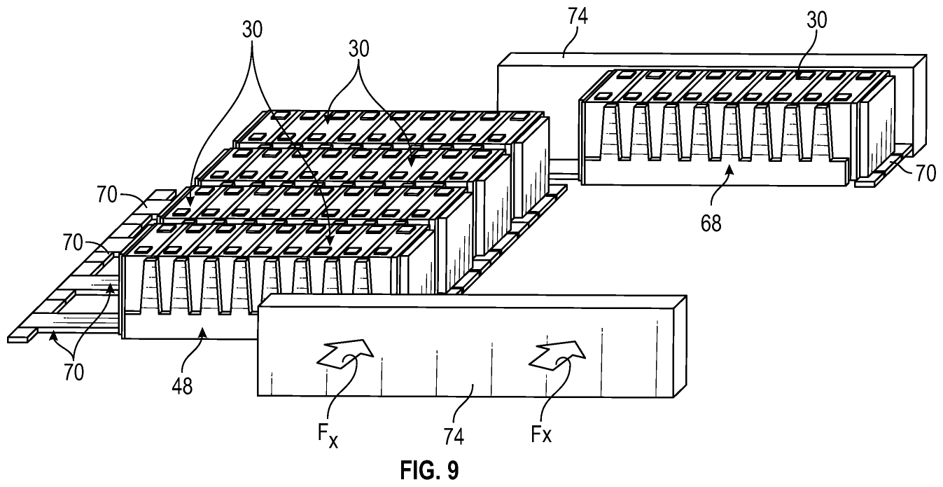

Referring now to FIG. 9, the cell row vises 70 of each cell stack 30 may be arranged adjacent to one another to form multiple rows of the cell stacks 30. The cell stacks 30 may then be compressed together using cell matrix joiner plates 74 to construct the cell matrix 32. The cell matrix joiner plates 74 may be configured for applying additional, compressive forces F_{X} for compressing the cell stacks 30 together in a direction that is generally perpendicular to the longitudinal axes of the cell stacks 30.

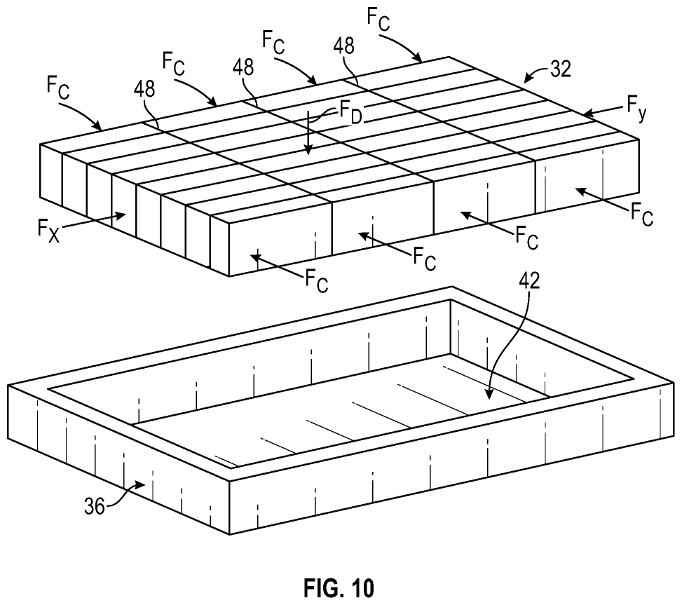

Next, as shown in FIG. 10, while maintaining both the compressive forces Fc and the compressive forces Fx, the cell matrix 32 may be moved, via a force F_{D}, into the cell-compressing opening 42 of the enclosure tray 36. The cell row vices 70 and the cell matrix joiner plates 74 are removed during this step, therefore the cell-compressing opening 42 may apply the compressive force about the entire perimeter of the cell matrix 32. The structural adhesive 62 may be applied between the projections 52 of each cell row separator 48 either before or after inserting the cell matrix 32 into the cell-compressing opening 42.

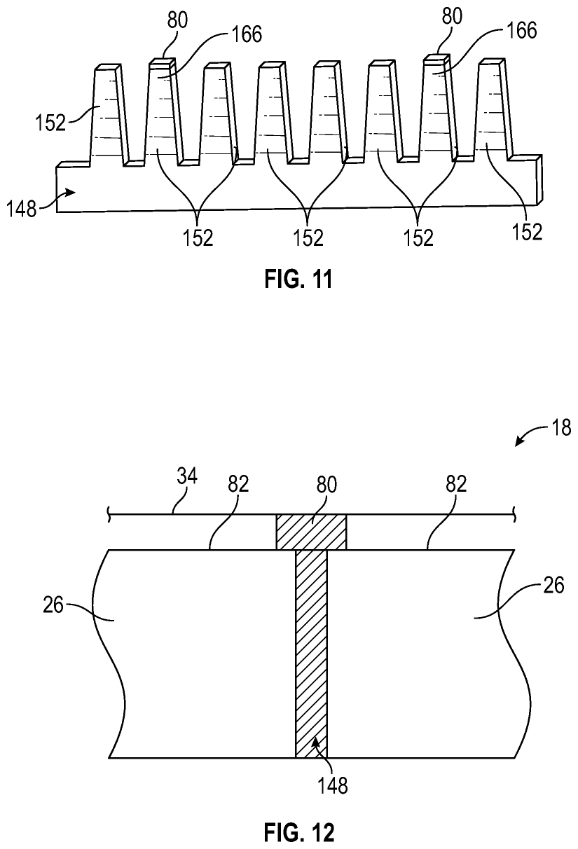

FIG. 11 illustrates another exemplary cell row separator 148. The cell row separator 148 is similar to the cell row separator 48 discussed above. However, in this embodiment, one or more projections 152 of the cell row separator 148 may include a stanchion 80. The stanchion 80 may be disposed at the distal end portion 166 of the projection 152

Referring to FIG. 12, the stanchions 80 may extend to a location above upper surfaces 82 of battery cells 26 of the cell stacks 30. The stanchion 80 may interface with an enclosure cover 34 of the traction battery pack 18 for supporting the enclosure cover 34 above the battery cells 26 (see, e.g., FIG. 12). The stanchions 80 could alternatively or additionally be used for various other purposes, such as for attaching and/or locating additional components (e.g., bus bar modules, wires, etc.) of the cell-to-pack battery system 20 above the battery cells 26, picking, moving, and placing the cell matrix 32 during assembly, etc.

The exemplary cell row separators of this disclosure provide cell stack separation within cell-to-pack battery systems. The exemplary separators can further provide solutions to various assembly complexities that may arise as a result of eliminating much of the array support structures associated with convention traction battery packs.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly; and
a cell-to-pack battery system housed within the enclosure assembly,
wherein the cell-to-pack battery system includes a first cell stack, a second cell stack, and a cell row separator arranged to structurally couple the first cell stack and the second cell stack together.

2. The traction battery pack as recited in claim 1, wherein the enclosure assembly includes an enclosure cover and an enclosure tray.

3. The traction battery pack as recited in claim 2, wherein the enclosure tray provides a cell-compressing opening for compressing the first cell stack and the second cell stack.

4. The traction battery pack as recited in claim 1, wherein the cell row separator is secured to the first cell stack by a first two-sided adhesive tape and is secured to the second cell stack by a second two-sided adhesive tape.

5. The traction battery pack as recited in claim 4, comprising a structural adhesive received between a first projection and a second projection of the cell row separator.

6. The traction battery pack as recited in claim 1, wherein the cell row separator is a polymer-based component.

7. The traction battery pack as recited in claim 1, wherein the cell row separator includes a base and a plurality of projections that protrude upwardly from the base.

8. The traction battery pack as recited in claim 7, wherein the plurality of projections are spaced apart from one another along a length of the base, and a gap extends between adjacent projections of the plurality of projections.

9. The traction battery pack as recited in claim 8, comprising a structural adhesive received within the gap.

10. The traction battery pack as recited in claim 1, wherein the cell-to-pack battery system establishes a total high voltage bus electrical potential of the traction battery pack.

11. A traction battery pack, comprising:
a cell stack;
a cell row separator attached to the cell stack and including a base, a first projection that extends from the base, and a second projection that extends from the base; and
a structural adhesive received within a gap extending between the first projection and the second projection.

12. The traction battery pack as recited in claim 11, wherein the cell row separator is a polymer-based component.

13. The traction battery pack as recited in claim 11, wherein the first and second projections are finger-like projections.

14. The traction battery pack as recited in claim 11, wherein the first and second projections taper toward a distal end portion.

15. The traction battery pack as recited in claim 11, comprising a second cell stack, and wherein the cell row separator is attached to the second cell stack.

16. The traction battery pack as recited in claim 15, wherein the cell row separator and the structural adhesive cooperate to structurally couple the cell stack and the second cell stack together.

17. The traction battery pack as recited in claim 11, wherein the cell row separator is secured to the cell stack by a two-sided adhesive tape.

18. The traction battery pack as recited in claim 11, wherein the cell stack includes a plurality of battery cells, and wherein the cell row separator provides a common datum reference plane for aligning the plurality of battery cells.

19. The traction battery pack as recited in claim 11, wherein the cell-to-pack battery system establishes a total high voltage bus electrical potential of the traction battery pack.

20. A method, comprising:
assembling a first cell stack;
attaching a cell row separator to the first cell stack;
arranging a second cell stack adjacent to the first cell stack;
compressing the first cell stack and the second cell stack together to form a cell matrix; and
while maintaining compression on the cell matrix, moving the cell matrix into a cell-compressing opening of an enclosure tray of a traction battery pack.
